(19) United States
(12) Patent Application Publication
(10) Pub. No.: US 2014/0067970 A1
(43) Pub. Date: Mar. 6, 2014

(54) SYSTEMS AND METHODS FOR ENGAGEMENT IN A POLITICAL PROCESS

(71) Applicant: Virtus Junxit, LLC, Los Angeles, CA (US)

(72) Inventor: Shaan Sharma, Los Angeles, CA (US)

(73) Assignee: Virtus Junxit, LLC, Los Angeles, CA (US)

(21) Appl. No.: 13/884,016

(22) PCT Filed: Sep. 21, 2012
(86) PCT No.: PCT/US2012/056451

§ 371 Date: May 8, 2013

Related U.S. Application Data
(60) Provisional application No. 61/538,485, filed on Sep. 23, 2011.

(51) Int. Cl. H04L 12/58

(52) U.S. Cl. CPC H04L 51/00
USPC 709/206

(57) ABSTRACT

Methods and related apparatus and compositions of matter for engaging a user in a political process are disclosed herein. In various aspects the methods may include the steps of notifying a verified user of an action item by electronic messaging, with the action item relating to a political issue preselected by the verified user. The methods may include the step of collecting an actual response to the action item generated by the verified user, and transmitting the actual response to a decision maker. The methods may include, in various aspects, creating a report card using a plurality of decision maker actions of the decision maker, with the report card indicative of the agreement between each decision maker action of a number of decision maker action with the corresponding actual responses of the verified user.

### CROSS-REFERENCE TO RELATED APPLICATIONS

The present application is a National Stage Application of PCT/US2012/056451 filed on 21 Sep. 2012, which claims priority and benefit of U.S. Provisional Patent Application No. 61/538,485 filed on 23 Sep. 2011 and entitled “SYSTEMS AND METHODS FOR USER ENGAGEMENT IN A POLITICAL PROCESS,” which is hereby incorporated by reference in its entirety herein.

### BACKGROUND OF THE INVENTION

1. Field

This disclosure relates to web based social network communications, and, more particularly, to systems and methods for user interactions in a political process.

2. Related Art

The United States is as a constitutional republic with political power exercised by representatives elected through a democratic political process. Each eligible citizen may participate in the political process by voting for these elected representatives, and by communicating their thoughts, concerns, and opinions to these elected representatives. However, as evidenced by actual voting, many eligible citizens choose not to participate in the political process except in presidential elections once every four years. For example, according to the U.S. Census Bureau, in 2008 only 64% of eligible citizens voted, a total of 131 million people, and only 71% of eligible citizens were registered to vote, which was actually a decrease of one percent compared to 2004. In 2008, at least 29% of eligible citizens in the U.S. were not registered to vote, and 7% of registered voters chose not to vote.

Citizen participation in the political process as evidenced by voting decreases in non-Presidential election years, with, for example, only 41% of voting-age and eligible citizens voting in the 2010 elections. That meant that a majority of eligible citizens chose not to participate in the political process at the federal level by voting in 2010. Of course, that also means that 41% of eligible citizens who did participate by voting made the electoral decisions for the other 59% of eligible citizens who failed to vote.

Citizen participation in the political process as evidenced by voting decreases from the federal level to the state and local level including referenda where citizens' votes have direct legislative power. For example, according to California's Secretary of State, less than 21% of eligible citizens voted in the May 2009 special election that included such issues as the approval of the state budget, the funding of education, the funding of children's services and mental health services.

Various factors may contribute to eligible citizens choosing not to participate in the political process. For example, the divisiveness of politics coupled with lack of privacy when participating in various aspects of the political process may dissuade some citizens from participating in the political process for fear of encountering the wrath of other citizens. Some citizens, for example, may be so involved in earning a living or caring for other family members that they lack the time to participate in the political process. Other citizens, for example, may be overwhelmed by information so as to be unable to focus on the political process. Citizens may lack information such as the identity of elected officials and the voting records of the elected officials. Citizens may lack information, for example, with respect to various pending legislative actions, elections, and referenda. Citizens may lack information, for example, with respect to mechanics of participating such as how to register to vote and the times and locations of polling places. Other constrains on time, the ability to travel, or the ability to communicate may inhibit citizens from participating in the political process.

Accordingly, there is a need for improved methods as well as related apparatus and compositions of matter for assisting citizens in participating in the political process.

### BRIEF SUMMARY OF THE INVENTION

These and other needs and disadvantages may be overcome by the methods and related apparatus and compositions of matter disclosed herein. Additional improvements and advantages may be recognized by those of ordinary skill in the art upon study of the present disclosure.

Methods are disclosed herein that, in various aspects, include the steps of notifying a verified user of an action item, the action item relating to a political issue preselected by the verified user and presenting to the verified user a proposed response to the action item, the proposed response being based upon a political profile of the verified user. The methods may include the steps of collecting an actual response to the action item from the verified user, transmitting the actual response to a decision maker, and performing the notifying and transmitting steps using a computer in networked communication, in various aspects. The methods may include performing the above steps of notifying, presenting, and collecting by using a summary action message. The summary action message may include the action item, an action item summary of the action item, a pro statement favoring the action item, a con statement opposing the action item, the proposed response to the action item, and a response interface for collecting the actual response, in various aspects. The methods, in various aspects, may include the step of receiving the actual response by the decision maker using a networked computer.

Related apparatus are disclosed herein. In various aspects, the apparatus may include a summary action message operatively received by a networked computer to present to a verified user an action item, an action item summary of the action item, a pro statement favoring the action item, a con statement opposing the action item, a proposed response to the action item based upon a political profile of the verified user, and a response interface allowing the verified user to input an actual response to the action item for transmission to a decision maker via networked communication.

In various aspects, computer readable media may be provided that includes computer readable instructions that, when executed, cause the computer to perform various steps of the methods disclosed herein. In various aspects, computer readable media may be provided that include computer readable instructions that, when executed, configure a computer as the apparatus disclosed herein.

This summary is presented to provide a basic understanding of some aspects of the apparatus and methods disclosed herein as a prelude to the detailed description that follows below. Accordingly, this summary is not intended to identify key elements of the apparatus and methods disclosed herein or to delineate the scope thereof.

### BRIEF DESCRIPTION OF THE DRAWINGS

FIG. 1 illustrates by schematic diagram an exemplary implementation of a system;

FIG. 2 illustrates by sketch an exemplary implementation of portions of the system of FIG. 1 including a user interface;

FIG. 3 illustrates by sketch an exemplary implementation of portions of the system of FIG. 1 including a summary action message (SAM);

FIG. 4 illustrates by process flow chart an exemplary implementation of portions of the system of FIG. 1;

FIG. 5 illustrates by process flow chart an exemplary implementation of portions of the system of FIG. 1;

FIG. 6 illustrates by process flow chart an exemplary implementation of portions of the system of FIG. 1;

FIG. 7 illustrates by sketch an exemplary implementation of portions of the system of FIG. 1 including a report card;

FIG. 8 illustrates by process flow chart an exemplary implementation of portions of the system of FIG. 1;

FIG. 9 by sketch an exemplary implementation of portions of political queries for determining a political profile of a verified user;

FIG. 10 illustrates an exemplary screenshot of portions of the user interface;

FIG. 11 illustrates an exemplary screenshot displaying the political profile of the verified user;

FIG. 12 illustrates an exemplary screenshot displaying the newsfeed;

FIG. 13 illustrates an exemplary screenshot displaying a summary action message (SAM);

FIG. 14 illustrates by schematic diagram an exemplary implementation of portions of the system of FIG. 1; and,

FIG. 15 illustrates by process flow chart an exemplary implementation of portions of the system of FIG. 1.

The Figures, including the subject matter disclosed therein, are exemplary only, and the exemplary implementations illustrated therein are selected to facilitate explanation. Where used in the various Figures, the same numerals designate the same or similar elements. Processes indicated in the various process flow charts are exemplary and the processes may be implemented in various sequences in various other implementations.

### DETAILED DESCRIPTION OF THE INVENTION

Methods and related systems and compositions of matter for engaging a user in a political process are disclosed herein. In various aspects the methods may include the steps of notifying a verified user of an action item, the action item relating to a political issue preselected by the verified user and presenting political information to the verified user, the political information relating to the action item using electronic messaging. The methods may include the steps of selecting a proposed response to the action item using a political profile of the verified user, presenting the proposed response to the verified user, collecting an actual response to the action item generated by the verified user, and transmitting the actual response to a decision maker, in various aspects, and various of the steps may employ electronic messaging. The methods may include, in various aspects, creating a report card using a plurality of decision maker actions of the decision maker, with the report card indicative of the agreement between each decision maker action of a number of decision maker action with the corresponding actual responses of the verified user.

The methods disclosed herein may be generally implemented, at least in part, in software having the form of computer readable instructions adapted to execute upon one or more computers to cause the one or more computers to implement at least some of the steps of the methods. Software may be, for example, in the form of high-level code such as C or Java, or may be in the form of machine code. In some aspects, the software may execute on one computer. In other aspects, two or more computers may communicate with one another via network, and the software may be organized in various ways such that portions of the software may be distributed over the two or more computers to be executed by the two or more computers.

The software may be configured into modules, and the modules may be organized in various ways in various aspects. Modules include routines, programs, components, data structures, etc., that perform particular tasks or implement particular abstract data types. Although generally described as implemented by software, the methods disclosed herein may be implemented in combination with other program modules and/or as a combination of hardware and software in various aspects.

As used herein, the terms “component” and “system” are intended to refer to a computer-related entity, either hardware, a combination of hardware and software, software, or software in execution. For example, a component may be a process running on a processor, a processor, a hard disk drive, multiple storage drives (of optical and/or magnetic storage medium), an object, an executable, a thread of execution, a program, and/or a computer. By way of illustration, both application software running on a server and the server can be a component. One or more components can reside within a process and/or thread of execution, and a component can be localized on one computer and/or distributed between two or more computers. By way of further illustration, a system may be a computer with software executing upon the computer.

Computer includes a terminal that may have a computer screen, keyboard, and mouse, and is linked by network to a server. In such an aspect, various software, including software disclosed herein, may execute on the one or more processors in the server, and the computer provides an input/output interface from the server to the user. Computer includes various cloud based computing devices. Computer further includes a computer with one or more processors, memory, computer screen(s), mouse, keyboard, storage device(s), and so forth. Computer screen includes one or more computer screens in communication with the computer that may be generally viewed by the user. Computer further includes, for example, single-processor or multiprocessor computers, minicomputers, mainframe computers, multiple computers, as well as personal computers, hand-held computing devices such as iPads® or iPods®, cellular telephones that include a microprocessor, communication devices that include a microprocessor, and microprocessor-based or programmable consumer electronics.

The compositions of matter disclosed herein include computer readable media. Computer readable media may be any available media that can be accessed by the computer and includes both volatile and non-volatile media, removable and non-removable media. For example, computer-readable media includes computer storage media and communication media. Computer readable media includes volatile media, non-volatile media, removable media, and non-removable media implemented in any method or technology for storage of information such as computer-readable instructions, data structures, program modules or other data. Computer readable media includes, but is not limited to, RAM, ROM, EEPROM, flash memory or other memory technology, CD-ROM, digital video disk (DVD) or other optical disk storage, magnetic cassettes, magnetic tape, magnetic disk storage or other magnetic storage devices, or any other medium that can be used to store the information and that can be accessed by the computer.

Network, as used herein, includes local area networks, wide area networks, cellular telephonic networks, broadband networks, the Internet, the cloud in general, and combinations thereof. Communication may be conducted over the network by various wired and wireless technologies and combinations thereof. Computers may be networked with one another, and storage, various input/output devices, servers, routers and suchlike may be provided about the network, as would be recognized by those of ordinary skill in the art upon study of this disclosure.

As would be recognized by those of ordinary skill in the art upon study of this disclosure, the methods, systems, and compositions of matter disclosed herein may be practiced in distributed computing environments where certain tasks are performed by processors that are linked by network. In a distributed computing environment, modules can be located in computer readable media distributed about the network, and various processors located about the network may execute the modules. The modules and/or processors may communicate with one another via the network.

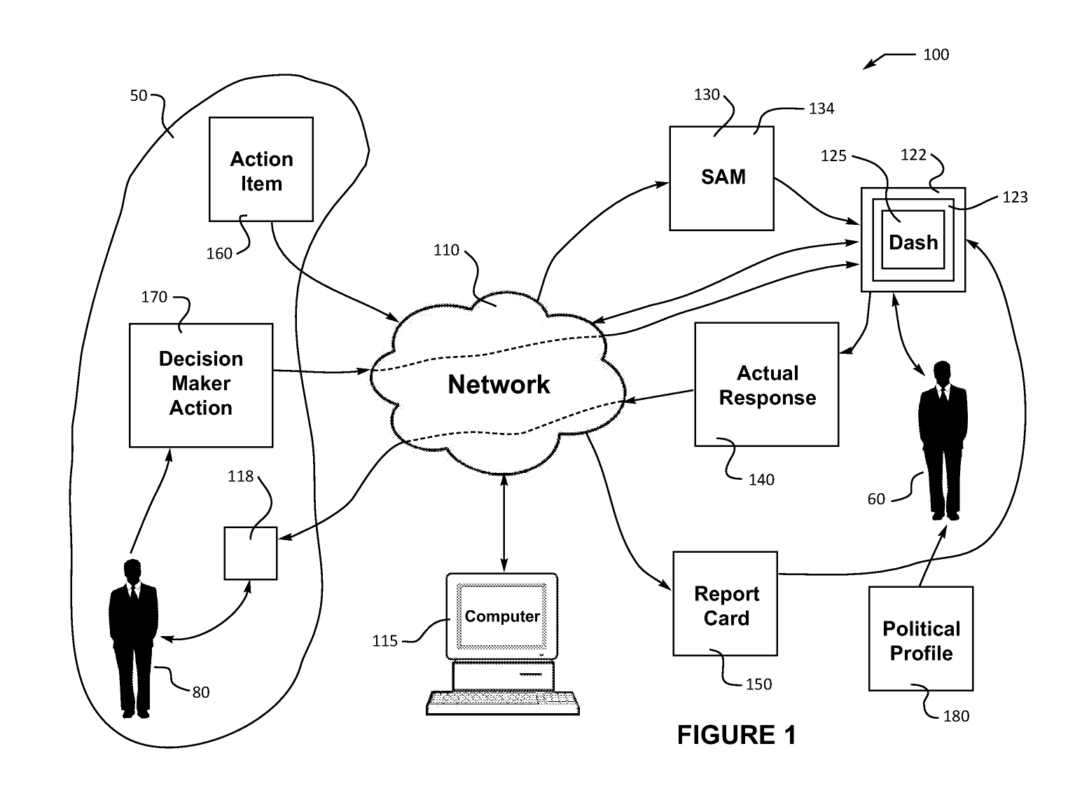

FIG. 1 illustrates portions of system 100 that engages verified user 60 in a political process 50. The verified user 60 is a user 40 whose identity has been affirmed by system 100, for example, through use of a credit card, driver's license, or other identification. Political process 50 may include various legislative processes, administrative processes, or other governmental processes at the local, regional, state, or federal level, or combinations thereof. For example, political process 50 may include various activities within the federal legislative process such as the introduction of a bill into the House of Representatives, various amendments to the bill, votes on the bill by committee(s), votes on the bill by the entire House of Representatives, votes on the bill in the Senate, reconciliation votes, and signature by the President. Political process 50 may include, for example, various activities within a state (including province or suchlike) legislative process such as the introduction of a bill in the state legislature, votes on the bill in the state legislature, and action on the bill by the governor of the state. As a further example, political process 50 may include local legislative processes related to the passage of local ordinances, passage of local taxes, resolution of zoning issues, and so forth. Local, in this context, may include a political subdivision that may be a political subdivision of a state such as a county, a group of counties, or a municipality. Local, in this context, may include other political subdivisions that may include at least portions of multiple states such as a metropolitan regional council, a watershed district, or a tribal council of an Indian tribe. As an additional example, political process 50 may include administrative rule making by state or federal agency, state or federal executive, state or federal commission, tribe, county or city administrator, or other administrative or executive entity. Political process 50 may include various processes within an international organization such as the United Nations, in various implementations.

As illustrated in FIG. 1, system 100 includes network 110, and the various components of system 100 may communicate with one another, at least in part, over network 110. The operation of system 100 including communications between the various components of system 100 may be controlled, at least in part, by service provider 115. For example, service provider 115 may interact with computer 118 and computer 122 via network 110, in this implementation, to communicate with computer 118, computer 122, and to control communications between computer 118 and computer 122. Service provider 115 may include computers and related software and hardware adapted to control the operation of system 100. Service provider 115, computer 118, and computer 122 are in networked communication with one another, as illustrated.

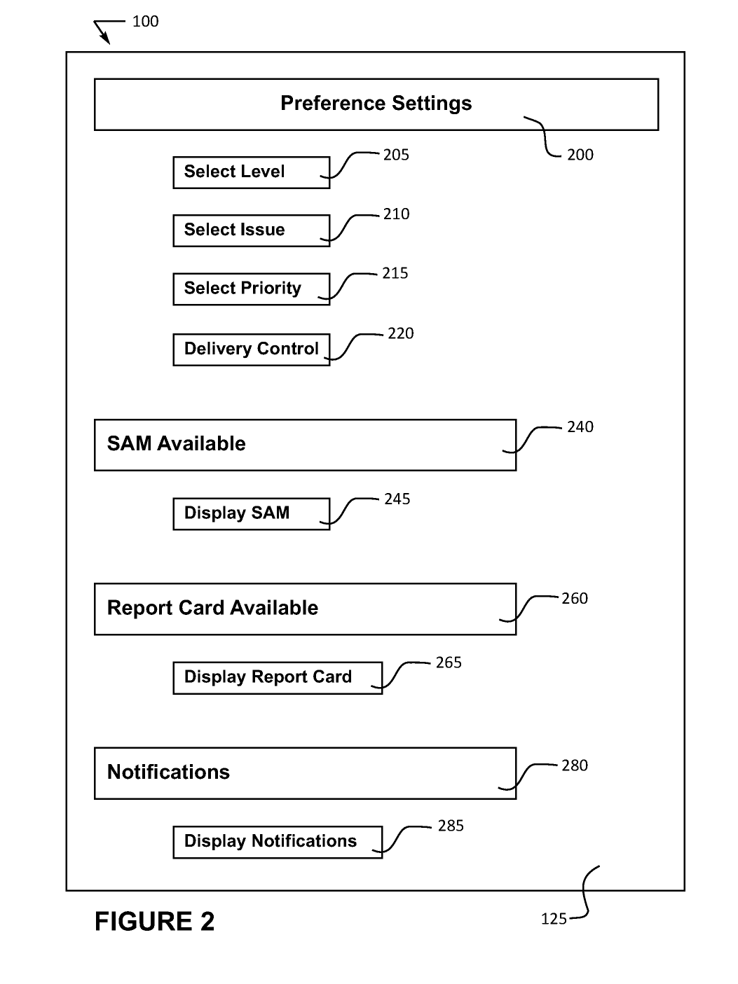

Verified user 60, as illustrated in FIG. 1, interacts with system 100 via computer 122. Computer 122 may include user interface 125 (see FIG. 2), which may be a software implemented interface on computer screen 123 of computer 122, that allows verified user 60 to interface with system 100, for example, by presenting information to verified user 60 and by allowing verified user 60 to select various parameters that control the presentation of information by system 100 to verified user 60. Political profile 180 may be linked with verified user 60 by system 100, where political profile 180 is indicative of the political orientation of verified user 60. For example, political profile 180 may indicate that verified user's 60 political orientation is socialist, conservative democrat, conservative republican, libertarian, enviro-green, evangelical conservative, libertarian, or so forth, as the case may be.

In FIG. 1, action item 160 is generated by political process 50, and action item 160 may be communicated over network 110 to service provider 115. Action item 160 may be any particular matter within political process 50, and action item 160 may have an action pending thereon. For example, action item 160 may be a particular bill in the legislature, and the pending action may be that the legislature is about to vote upon the bill. As a further example, action item 160 may be an issue and one or more actions may be pending related to the issue. As yet a further example, action item 160 may be an issue, and system 100 may act to poll the opinions of verified users 60 related to action item 160.

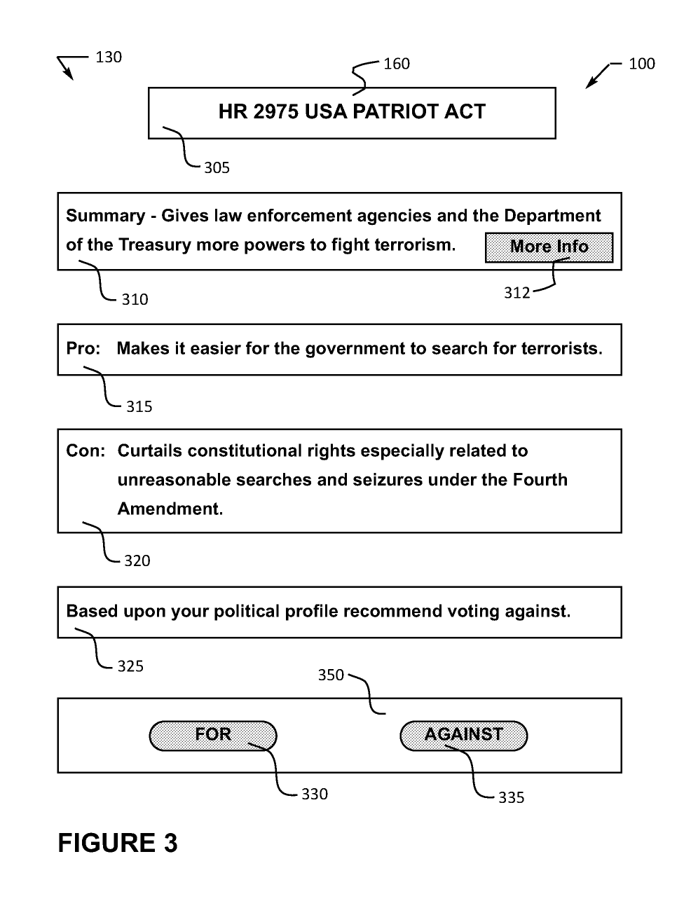

In response to action item 160, service provider 115 generates Summary Action Message (SAM) 130 (see FIG. 3), as illustrated, where SAM 130 is electronically configured for transmission to the verified user 60 via network 110 and is operationally received by computer 122, for example, to present action item summary 310, pro statement 315, com statement 320, proposed response 325, and response interface 350. In the illustrated implementation, SAM 130 is transmitted as electronic messaging via network 110 to computer 122, and computer 122 presents SAM 130 to verified user 60. Computer 122 may present SAM 130 to verified user 60 using user interface 125 on computer screen 123. In various implementations, SAM 130 may be generated based upon the generation of action item 160, and SAM 130 may include an action item summary 310 of the action item 160, a pro statement 315 favoring action item 160, a con statement 320 opposing action item 160, and a proposed response 325 to action item 160 selected based upon political profile 180 of verified user 60.

SAM 130 may include a response interface 350 that allows the verified user 60 to generate an actual response 140 to action item 160. The actual response 140 may be transmitted to decision maker 80, and SAM 130 may be operational to transmit actual response 140. In the illustrated implementation, actual response 140 is transmitted as electronic messaging via network 110 to computer 118, and computer 118 presents actual response 140 to decision maker 80. The actual response 140 may be binary, in some implementations, for example, for or against, agree or disagree, yes or no. In other implementations, the actual response 140 may be some type of sliding scale, for example, the selection of a response between 1 and 5 with 1 being strongly yes and 5 being strongly no. The sliding scale may be non-numeric, for example, the selection of a response chosen from strongly agree, agree, neutral, disagree, or strongly disagree. Virtual dials, buttons, slides, and so forth may be provided in SAM 130 to collect the actual response 140.

Decision maker 80 may be an actor in political process 50 such as, for example, a U.S. senator, a member of the U.S. House of Representatives, a member of the legislature of a state, a county commissioner, a mayor, a city counselor, a member of some local or regional governing body, an administrator within a government agency, an agent or representative of such persons such as an assistant within an office of a U.S. senator. Decision maker 80 may be, for example, an unofficial actor within political process 50 such as a lobbyist, lobbying organization, political action committee (PAC), politically oriented non-governmental organization (NGO), or polling organization that samples opinions. The decision maker 80 has the ability to take decision maker action 170, for example, vote or to take other actions in representation of the verified user 60 in the political process 50, and the decision maker 80 may represent a number of verified users, such as verified user 60, in the political process 50.

The verified user 60 can act only through decision maker 80 in the political process 50. Decision maker 80 may act independent of verified user 60 in taking decision maker action 170, such that the decision maker 80, not the verified user 60, determines the decision maker action 170 taken. Because the decision maker 80 may act independently of the verified user 60, the decision maker action 170 of decision maker 80 may be in accord with the actual response 140 of verified user 60 or the decision maker action 170 of decision maker 80 may be contrary to the actual response 140 of verified user 60. The verified user 60 may convey and actual response 140 to decision maker 80 but verified user 60 cannot bind decision maker 80 to act in accord with actual response 140. That is, the decision maker 80 is not obligated to act in accord with a majority (including plurality) of actual responses, such as actual response 140, received. The decision maker 80 is free to ignore any number of actual responses 140 in taking decision maker action 170. The decision maker 80 may take decision maker action 170 without having received any actual response 140, for example, in the event that verified user 60 declines to submit actual response 140. Accordingly, decision maker action 170 of decision maker 80 is decoupled from actual response 140.

In various implementations, actual responses, such as actual response 140, may be aggregated in various ways to form an aggregation of actual responses, and this aggregation of actual responses may be presented via network 110 to decision maker 80. A user interface similar to user interface 125 may be used to present the actual responses to decision maker 80 using computer 118, and decision maker 80 may control the presentation of actual responses as well as other actions or features of system 100 using the user interface.

As illustrated in FIG. 1, decision maker 80 takes decision maker action 170, where decision maker action 170 is some action related to action item 160. For example, if action item 160 is a bill pending a vote in the U.S. House of Representatives, decision maker 80 is a congressman, and decision maker action 170 is the vote of decision maker 80 on the bill, namely, action item 160. Following this example, decision maker action 170 may be any of various other actions with respect to the bill such as a vote on tabling the bill, vote on amendment of the bill, a cloture vote, and so forth. Decision maker action 170 may be other legislative acts performed by a decision maker, such as decision maker 80, when political process 50 occurs within a legislative context. Decision maker 80 may include a senator, pre this example, when the Senate takes up the bill, and may include the president when the bill is presented to the president for signature following congressional approval. Accordingly, decision maker action 170 may include the president either signing or vetoing the bill as well as congressional actions taken to override a presidential veto, per this example. Per this example, congress includes both the U.S. House of Representatives and the U.S. Senate. T

The verified user does not control the generation of an action item 160. Continuing the example of a bill before congress or the president, while the verified user 60 may select the political issue of bills (action items) that the verified user wishes to view in SAM, the verified user 60 does not generate the specific bill (action item) being acted on by decision maker 80, and the verified user 60 does not control in any way the timing or nature of any action such as decision maker action 170 related to the bill (action item).

When political process 50 occurs within an administrative context, decision maker 80 may be an administrator, action item 160 may be a particular administrative matter, and decision maker action 170 may be an administrative act related to the particular administrative matter performed by a decision maker 80 in the administrative context. When political process 50 occurs within an executive context, decision maker 80 may be an executive, action item 160 may be a particular executive matter, and decision maker action 170 may be an executive act related to the particular executive matter performed by decision maker 80 in the executive context.

Decision maker action 170 may be transmitted over network 110 and decision maker action 170 may be reported to verified user 60 using computer 122. Service provider 115 may control the transmission of decision maker action 170 including the reporting of decision maker action 170 to verified user 60. In various implementations, one or more decision maker actions 170 may be collected to create a report card 150, and the report card 150 may be presented to verified user 60 using computer 122. User interface 125 may present decision maker action 170, report card 150, or both decision maker action 170 and report card 150 to verified user 60.

In various implementations, the report card 150 may include an item by item comparison of several decision maker actions, such as decision maker action 170, with corresponding actual response, such as actual response 140, from verified user 60. The corresponding decision maker actions may be compared to the corresponding suggested responses, such as suggested response 325. In various implementations, the decision maker actions may be used to determine a political profile of the decision maker, and the political profile of the decision maker may be included in the report card 150.

The decision maker action 170 may be input into network 110 automatically by system 100 in some implementations. Service provider 115 of system 100 may scrape, including various interconnections and interactions, various databases including web sites and other electronic sources of information maintained generally within political process 50 to obtain the decision maker action 170, and these databases may be updated more or less in real time. Service provider 115 may scrape databases maintained by a governmental body within political process 50. For example, service provider 115 may scrape databases maintained by a legislative body such as the U.S. Senate in order to obtain decision maker action 170, and these databases may collect decision maker actions more or less in real time, for example, as the decision maker 80 votes on the floor of the Senate. Per this example, the casting of the vote may act to input the vote into the database. Service provider 115 may scrape databases maintained by various other parties such as news organizations, NGO's, and so forth, to obtain the decision maker action 170. In other implementations, decision maker action 170 may be entered clerically into system 100. Optical character recognition (OCR) may be employed to enter decision maker actions 170 into system 100 in some implementations.

FIG. 2 illustrates an implementation of user interface 125 of system 100 that allows the verified user 60 to interact with system 100. User interface 125 may have the same general appearance when presented via website, mobile app, widget, or so forth, in various implementations. As illustrated in FIG. 2, user interface 125 includes preference settings 200 that allow the verified user 60 to control various aspects of system 100. Preference settings 200, in this implementation, include a select level interface 205 allowing the verified user 60 to select the governmental level of the political process 50 that that the verified user 60 wishes to monitor, for example, via SAM 130 or report card 150. For example, the verified user 60 may select political process 50 as being at the local level, regional level, state level, or federal level and combinations thereof, and the verified user 50 may select political process 50 as legislative branch, executive branch, or combinations thereof using select level interface 205.

Preference settings 200, in the illustrated implementation, include select issue interface 210 that allows verified user 60 to select one or more issues that verified user 60 wishes to monitor, for example, via SAM 130 or report card 150. For example, verified user 60 may select issues such as 4^{th} Amendment issues, 2^{nd} Amendment issues, issues related to agriculture, issues related to foreign trade, issues related to business taxation, and so forth, as desired using select issue interface 210. The issues may be very broad, very specific, or combinations thereof, in various aspects.

Preference settings 200, as illustrated in FIG. 2, include select priority interface 215 that allows the user to select a threshold level of importance for action items 160 related to the one or more issues that verified user 60 has chosen to monitor using the select issue interface 210. Accordingly, SAM 130 may be transmitted to computer 122 for presentation to user 60 when the level of importance of the action item 160 meets or exceeds the threshold level of importance.

For example, the verified user 60 may select a threshold level of importance having a value of 1, 2, 3, 4, or 5 with 1 being of minimal importance and the threshold level of importance increasing from 1 to 5 with 5 being of major importance. In this example, action items 160 that are generated by the political process 50 selected by verified user 60 and that are associated with the issue selected by the verified user 60 are filtered according to level of importance. If, per this example, verified user 60 selects the threshold level of importance as 1 then all action items 160 cause system 100 to generate SAM 130 that is transmitted to computer 122 for presentation to verified user 60. If, per this example, verified user 60 selects the threshold level of importance as 5 then only the most important action items 160 cause system 100 to generate SAM 130 that is transmitted to computer 122 for presentation to verified user 60. Intermediate values for the threshold level of importance would cause system 100 to generate SAM 130 for action items 160 having some intermediate level of importance. The threshold level of importance may be set by the user using some sort of numeric scale as in this example or may be set according to some sort of rating scale such as low, medium, high, or in other ways, in various implementations.

As illustrated in FIG. 2, preference settings 200 include delivery control interface 220. Delivery control interface 220 may allow verified user 60 to control the transmission of SAM 130, actual response 140, or report card 150. Delivery control interface 220 may allow verified user 60 to control the display of SAM 130, actual response 140, report card 150, or may allow verified user 60 to otherwise control the verified user's interactions with system 100 including the flow of information from system 100 to verified user 60 as well as various features of system 100. The delivery control interface 220, for example, may allow verified user 60 to designate the method of delivery of SAM 130 (e.g. text message, email, website, mobile app, etc.) The delivery control interface 220, for example, may allow verified user 60 to designate the frequency of delivery of SAM 130 such as upon generation of the SAM 130, hourly, daily, or so forth. Delivery control interface 220 may allow the verified user 60 to limit the total number of SAMs 130 delivered during a specified period. For example, the verified user 60 may specify that no more than 10 SAMS 130 may be delivered during any 24 hour period.

User interface 125, as illustrated in FIG. 2, includes SAM available interface 240 that notifies verified user 60 that SAM 130 is available for display and display SAM interface 245 that allows verified user 60 to display SAM 130.

User interface 125, as illustrated in FIG. 2, includes report card available notification interface 260 that notifies verified user 60 that report card 150 is available for display and display report card interface 265 that allows verified user 60 to display report card 150.

User interface 125, as illustrated in FIG. 2, includes notification available interface 280 that notifies verified user 60 that one or more notifications are available for display and display notifications interface 285 that allows verified user 60 to display the notification(s). Notifications may include various news feeds or other information sources, and verified user 60 may select the news feeds or other information sources to include such news feeds or other information sources as verified user 60 considers trustworthy.

In implementations wherein the verified user 60 selects multiple issues, the threshold level of importance, the delivery of SAM's 130, and other controls and features may be set independently for each issue. For example, verified user 60 selects issue₁ and issue₂. Following this example, the verified user 60 may select issue₁ at the state level with level of importance of 4 and a frequency of delivery of SAM 130 as daily, and the verified user 60 may select issue₂ at the federal level with level of importance of 1 and a frequency of delivery of SAM 130 as half-hourly. In various implementations, there may be a limit on the total number of SAMs 130 delivered per day, total number of SAMS 130 per issue delivered per day, or the frequency of delivery or number of SAMs 130 delivered may be limited in other ways. Other features may be set for each issue in various implementations.

Performance settings 200, select level interface 205, select issue interface 210, select priority interface 215, delivery control interface 220, SAM available notification interface 240, display SAM interface 245, report card available notification interface 260, display report card interface 265, notification available interface 280, and display notifications interface 285 may be implemented in various ways in various implementations, for example, through the user of buttons, pull down menus, fields for data entry, radio buttons, touch screen selectable fields, mouse selectable fields, layered hierarchy, and other interfaces with the user and structures, as would be readily recognized by one of ordinary skill in the art upon study of this disclosure.

FIG. 3 illustrates an implementation of SAM 130 of system 100 for the presentation of political information 134 to verified user 60. Political information 134, for example, may include action item description 305 of action item 160, action item summary 310, pro statement 315 favoring action item 160 and con statement 320 opposing action item 160, and proposed response 325 to action item 160.

In this implementation, SAM 130 include action item description 305 of action item 160, which is bill HR 2975 pending before the U.S. House of Representatives with short title of “USA Patriot Act.” The action item description, in this implementation, includes as descriptive elements the designation of the bill (HR 2975) and the informal title of the bill (“USA Patriot Act”). Action item 305 may include more or fewer descriptive elements or information, in various other implementations.

SAM 130, as illustrated in FIG. 3, includes an action item summary 310 of the action item 160, which is a brief summary description of action item 160. Action item summary 310 includes a summary of HR 2975, in this implementation. Link 312 may take the verified user 60 to additional information such as a more detailed description of action item 160, the actual contents of action item 160 (the actual language of HR 2975), and to various critiques that may be supportive of or opposed to action item 160, or to the websites of individuals or organizations that support or oppose action item 160. Other informational features may be included in action item summary 310 or in links to action item summary 310, in various other implementations.

SAM 130, as illustrated in FIG. 3, includes pro statement 315 favoring action item 160 and con statement 320 opposing action item 160. Links may be provided in conjunction with pro statement 315 to various critiques that may be supportive of action item 160, or to the websites of individuals or organizations that support action item 160. Links may be provided in conjunction with con statement 320 to various critiques that may be opposed to action item 160, or to the websites of individuals or organizations that oppose action item 160.

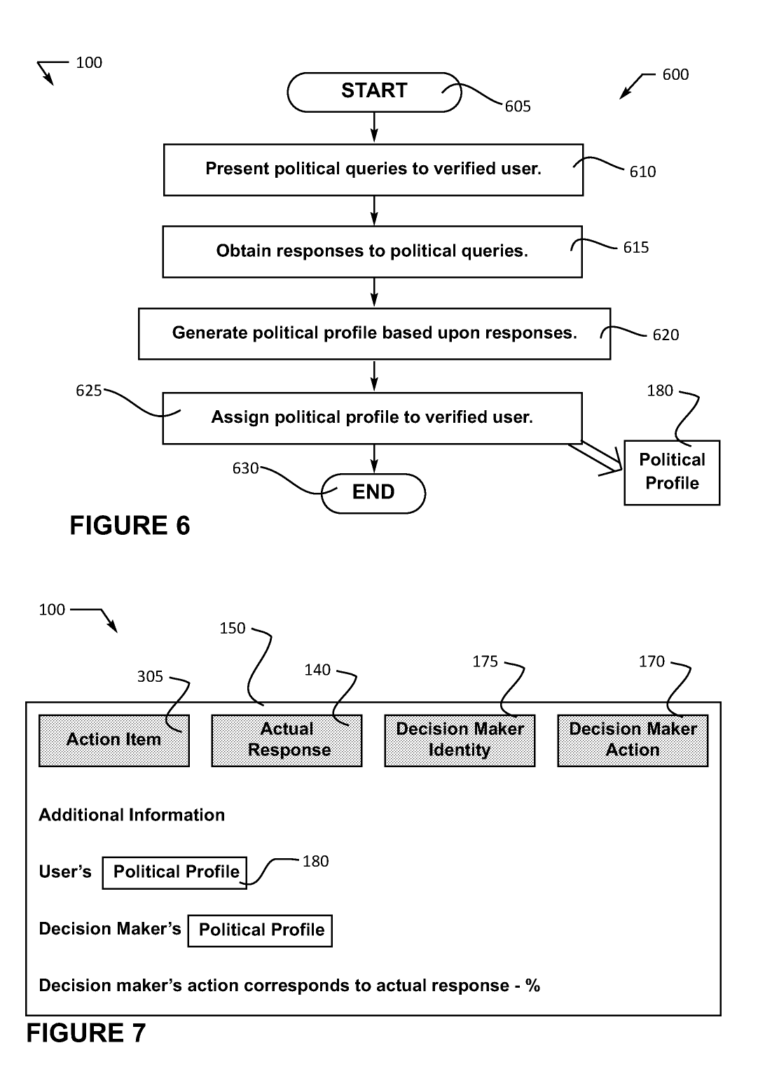

SAM 130, as illustrated in FIG. 3, includes proposed response 325 to action item 160 selected based upon political profile 180 (see FIGS. 1, 6) of verified user 60. Proposed response 325 may recommend a user response to action item 160 as would be typical of those having the verified user's 60 political profile 180. For example, if political profile 180 indicates that verified user 60 is libertarian, the proposed response 325 may recommend that verified user 60 oppose action item 160 (HR 2975 in this example of FIG. 3) as libertarians may generally oppose governmental intrusions into the privacy of the individual. In this example, the proposed response 325 includes the recommendation portion “oppose action item 160” and a why portion “libertarians may generally oppose governmental intrusions into the privacy of the individual.”

Continuing this example, if political profile 180 indicates that verified user 60 is conservative Democrat, the proposed response 325 may recommend that verified user 60 support action item 160 (HR 2975 in this example) as conservative Democrats may generally favor strong governmental actions to protect the national security of the U.S. As with action item summary 310, additional links may be provided in conjunction with pro statement 315, con statement 320, or proposed response 325 that allow verified user 60 to access information with respect to action item 160 such as editorial comments from various news sources, analyses from bloggers, the positions of various organizations, statements of political figures, and so forth.

The SAM 130, in some implementations, may include an indication that the action item 160 includes unrelated items. For example, a pork alert may indicate that the action item 160 includes pork, earmarks, special interest legislation, backroom deals, and other features (or lack of such features) that may be of interest to the verified user 60.

As illustrated in FIG. 3, SAM 130 includes response interface 350 that allows the verified user 60 to generate an actual response 140 to action item 160 that may be indicative of verified user's 60 support for action item 160 or opposition to action item 160. As illustrated, response interface 350 includes response button 330 and response button 335, which may be virtual on a screen, that allow verified user 60 to generate actual response 140. By selecting response button 330, verified user 60 indicates support for action item 160, and this indication of support is collected into actual response 140, in this implementation. By selecting response button 335, in this implementation, verified user 60 indicates opposition to action item 160 and this indication of opposition is collected into actual response 140. Response interface 350 may allow verified user 60 to recommend other courses of action or voice other opinions in various other implementations that may be collected into actual response 140, and various input fields may be included in response interface 350 accordingly. Actual response 140 may then be transmitted to decision maker 80 to convey the opinion of verified user 60 to decision maker 80.

In various implementations, actual response 140 may be aggregated with a number of actual responses 140 from a number of verified users 60, and this aggregated response may be presented to decision maker 80. The aggregated response may include various statistical summaries or other summaries of the actual responses from which the aggregated response is formed. For example, the aggregated response may present the total number of actual responses, the number of actual responses in favor of the action item, the number of actual responses opposed to the action item, or other verified user comments or responses including summaries thereof.

System 100 may employ heuristics such as artificial intelligence to tailor SAM 130 including proposed response 325 to the specific verified user 60. Other aspects of system 100 may be tailored to verified user 60 using various heuristic technologies, so that system 100 conforms to verified user 60 over time based upon interactions of verified user 60 with system 100.

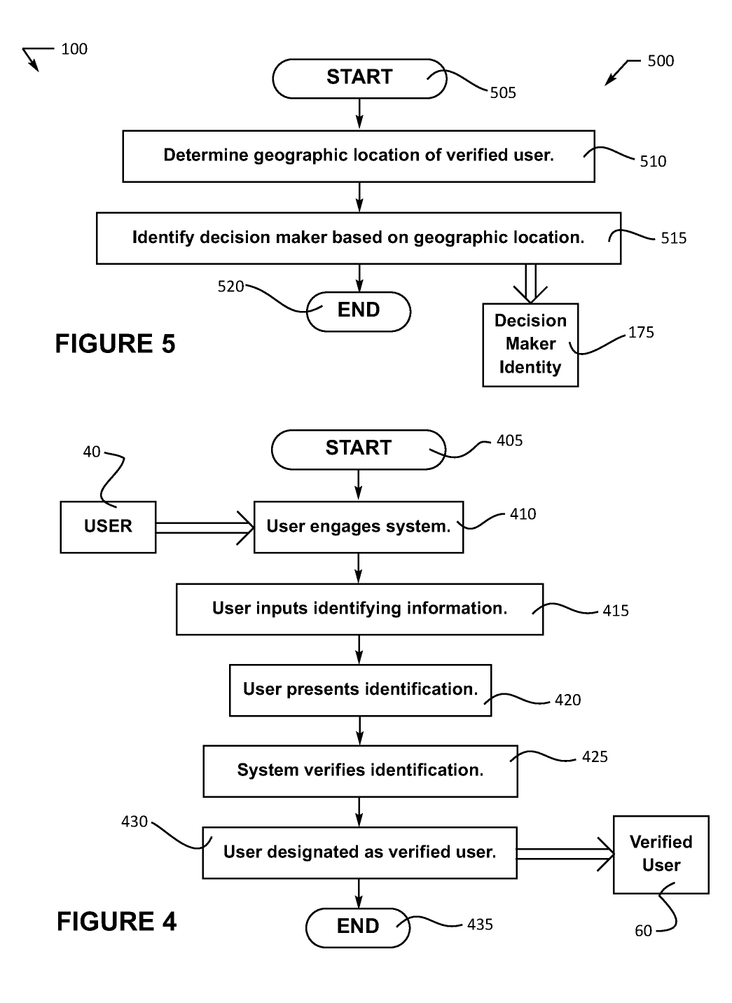

FIG. 4 illustrates portions of system 100 including component 400, which is a process operable to verify a user 40 to create verified user 60 from user 40. User 40 may be an individual desirous of using system 100, and user 40 may engage system 100 in order to obtain authorization to use system 100. As illustrated in FIG. 4, component 400 is entered at step 405. User 40 engages system 100 at step 410, in this implementation. At step 415 of this implementation, user 40 inputs identifying information that identifies user 40. For example, user 40 may input name, address, telephone number, citizenship, email, and so on at step 415. The user 40 may input demographic information including demographic information that may be useful in polling. Polling may include various opinion surveys, marketing surveys, and so forth. At step 420 of this implementation, user 40 presents identification, for example, a driver's license, passport, major credit card, and so forth that verifies the identifying information that user 40 had input in step 415. The identification verifies the identity of the user 40.

At step 425 of this implementation, component 400 of system 100 verifies the veracity of the identification presented by user at step 420. At step 425 of this implementation, component 400 of system 100 may verify the veracity of the identifying information input by user 40 at step 415. Assuming that the identifying information input at step 415, the identification presented at step 420, or both the identifying information input at step 415 and the identification presented at step 420 are verified, meaning found to be valid and accurate, at step 425, component 400 of this implementation of system 100 proceeds from step 425 to 430. At step 430, user 40 is designated as verified user 60 by system 100 thereby creating verified user 60 from user 40. This implementation of component 400 terminates at step 435. In other implementations, user 40 may be granted access to at least portions of system 100 without verification by component 400 or when user 40 fails step 425, and such access by user 40 to at least portions of system 100 may be limited in time or limited in various other ways. There may be delay in the performance of step 425 and user 40 may be granted access to at least portions of system 100 while step 425 is being performed. Component 400 may be implemented periodically, for example, to re-verify verified users, update demographic information of the verified user 60, or update identifying information of verified user 60, and such updates may be performed independent of verified user 60 by using various databases including other information sources.

FIG. 5 illustrates portions of system 100 including component 500, which is a process operable to identify decision maker 80 based upon the geographic location of verified user 60 thereby identifying the decision maker identity 175 of decision make 80. For example, decision maker 80 may be a congressional representative that represents the geographic location of verified user 60, i.e. verified user 60 resides in the district represented by the decision maker 80. Following this example, system 100 determines the particular congressional district that verified user 60 resides within using the geographic location of verified user 60, and, thus, identifies the decision maker identity 175 as the congressional representative of the particular congressional district within which verified user 60 resides.

As illustrated in FIG. 5, component 500 of system 100 is entered at step 505. At step 510, this implementation of component 500 of system 100 determines the geographic location of verified user 60. The geographic location of verified user 60 may be determined at step 510, for example, from identifying information input at step 415, the identification presented at step 420 of component 400 of system 100 illustrated in FIG. 4, or from the GPS coordinates of a mobile device. At step 515, in this illustrated implementation, the decision maker identity 175 of decision maker 80 is identified using the geographic location of the verified user 60 and the decision maker identity 175 is output. This implementation of component 500 terminates at step 520. Component 500 may be implemented periodically, for example, to determine the geographic location of verified user 60, and such updates may be performed independent of verified user 60 by using various databases including other information sources as well information related to the verified user 60 such as, for example, GPS coordinates from a mobile device.

FIG. 6 illustrates portions of system 100 including component 600, which is a process operable to determine political profile 180 of verified user 60. Component 600, as illustrated, is entered at step 605. At step 610, in this implementation, a set of political queries 182 is presented to verified user 60 that are designed to determine the political orientation of verified user 60. Verified user 60 responds to the political queries 182 at step 615 of component 600, as illustrated. At step 620 of this implementation of component 600, political profile 180 is generated based upon the responses obtained at step 615. Political profile 180 is assigned to verified user 60 and output from component 600 at step 625, as illustrated. This implementation of component 600 terminates at step 630. In various implementations, system 100 may determine political profile for particular categories so that a plurality of political profiles 180 are assigned to verified user 60. For example, verified user may have a conservative Republican political profile with respect to social issues and may be generally libertarian with respect to economic issues. As a further example, when verified user 60 selects a particular issue, the political profile 180 may be generated for verified user 60 with respect to that particular issue. System 100 may allow the verified user 60 to override the political profile 180 so that the verified user 60 may substitute a political profile 180 of the verified user's 60 choosing, in various implementations.

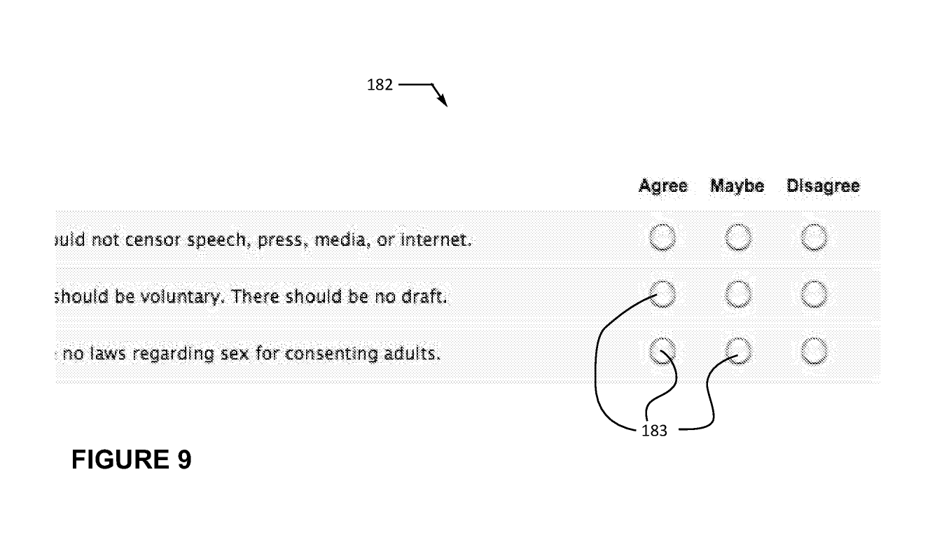

The political queries 182 may be modeled on or linked to “The World's Smallest Political Quiz” available from Advocates for Self-Government, 1010 N Tennessee St Suite 215, Cartersville, Ga. at http://www.theadvocates.org/quiz. Portions of exemplary political queries 182 as taken from “The World's Smallest Political Quiz” are illustrated in FIG. 9, in various implementations. As illustrated in FIG. 9, the verified user 60 may select an answer to a particular political query by selecting the corresponding button 183. The verified user's 60 selections are then analyzed to define the political profile 180 of the verified user 60.

The central insight of the political model underlying “The World's Smallest Political Quiz” is that the major difference between the various political philosophies that define political belief is the amount of government control over human action. The verified user 60 may respond to the ten political queries 182 that comprise “The World's Smallest Political Quiz.” The responses of the verified user 60 to the ten political queries 182 of “The World's Smallest Political Quiz” indicate the amount of government control over human action that the verified user 60 favors, and, thus, determine the political profile 180 of the verified user 60. In particular, the political queries 182 in “The World's Smallest Political Quiz” are directed toward the amount of government control over economic issues and the amount of government control over social issues that the verified user favors. The political profile 180 may then be expressed by position on a plane with abscissa denoting economic freedom and the ordinate denoting personal freedom. The origin is defined by maximum government control—lack of economic freedom and lack of personal freedom—as exemplified by totalitarian states such as fascist or communist states.

Other systematic methodologies exist for the determination of the political profile 180 of verified user 60 such as, for example, the methodology generally elucidated in Tim Groseclose, “Left Turn: How Liberal Media Bias Distorts the American Mind,” St. Martin's Press (Jul. 19, 2011) and a corresponding set of political queries 182 may be found at http://www.timgroseclose.com/calculate-your-pq/ The Groseclose political queries 182 are based upon votes on specific pieces of legislation and may be used to define the political profile 180 of a particular decision maker based upon the particular decision maker's votes on the specific pieces of legislation. The Groseclose political queries 182 may be used to define the political profile 180 of the verified user 60 based upon how the verified user 60 would vote on the specific pieces of legislation.

FIG. 7 illustrates report card 150 of system 100. As illustrated in FIG. 7, report card 150 includes action item summary 305 of action item 160, actual response 140, decision maker identity 175, and decision maker action 170. Verified user 60 may review action item summary 305 of action item 160, verified user's 60 actual response 140 to action item 160, the decision maker identity 175 of decision maker 80, and the decision maker action 170 of decision maker 80 by viewing report card 150. Accordingly, by reviewing report card 150, verified user 60 may ascertain the correspondence or lack of correspondence between verified user's 60 actual response 140 and decision maker's 80 decision maker action 170. Correspondence between verified user's 60 actual response 140 and decision maker's 80 decision maker action 170 may indicate that decision maker 80 represents the political views of verified user 60 in political process 50. In contrast, when the decision maker's 80 decision maker action 170 does not correspond to verified user's 60 actual response 140, this may indicate that decision maker 80 does not represents the political views of verified user 60 in political process 50. Thus, the report card 150 may allow verified user 60 to determine whether or not decision maker 80 represents the political views of verified user 60 in political process 50. Some implementations may generate recommendation to not re-elect decision maker 80 when the current term of decision maker 80 is about to expire and the decision maker's 80 decision maker action 170 does not correspond to verified user's 60 actual response 140, for example, some number of times or on one or more high priority action items 160

Report card 150 may include a number of action item summaries of a number of action items 160, such as action item summary 305 of action item 160, along with a corresponding number of actual responses and number of decision maker actions, such as actual response 140 and decision maker action 170. Accordingly, report card 150 may allow verified user 60 to review a number of decision maker actions 170 with respect to a number of action items 160 in order to determine whether or not decision maker 80 represents the political views of verified user 60 in political process 50.

Report card 150, as illustrated, includes additional information, for example, the verified user's 60 political profile 180. A political profile similar to political profile 180 may be generated for decision maker 80, so that verified user 60 can compare both political profile 180 and the political profile of decision maker 80, for example, in order to determine the degree to which decision maker 80 represents verified user's political orientation. The additional information may include, as illustrated in FIG. 7, an indication as to how frequently decision maker actions 170 correspond to actual responses 180. Other information may be included in report card 150 that may allow the verified user 60 to evaluate decision maker 80, in various other implementations.

Report card 150 may include additional information such as various aggregations of actual responses of a number of verified users. For example, the report card may include an aggregation of the actual responses of verified users within a congressional district with respect to a particular action item, a political profile for the verified users within the congressional district, corresponding decision maker action so that verified user 60 may determine how well the congressman (the decision maker 80) is representing the district as a whole. Decision maker actions 170 may be compared with recommendations of various NGO's and so forth to determine how the decision maker actions 170 of the decision maker 80 align with the NGO. For example, the decision maker actions (votes) of the congressman (the decision maker) may be compared with the recommendations of the National Rifle Association to indicate how supportive the decision maker 80 is of 2^{nd} Amendment rights as promoted by the National Rifle Association.

Donation link 187 may be provided. Selection of donation link 187 allows the verified user 60 to donate to the decision maker 80, and the verified user may choose to donate based upon the information in report card 150.

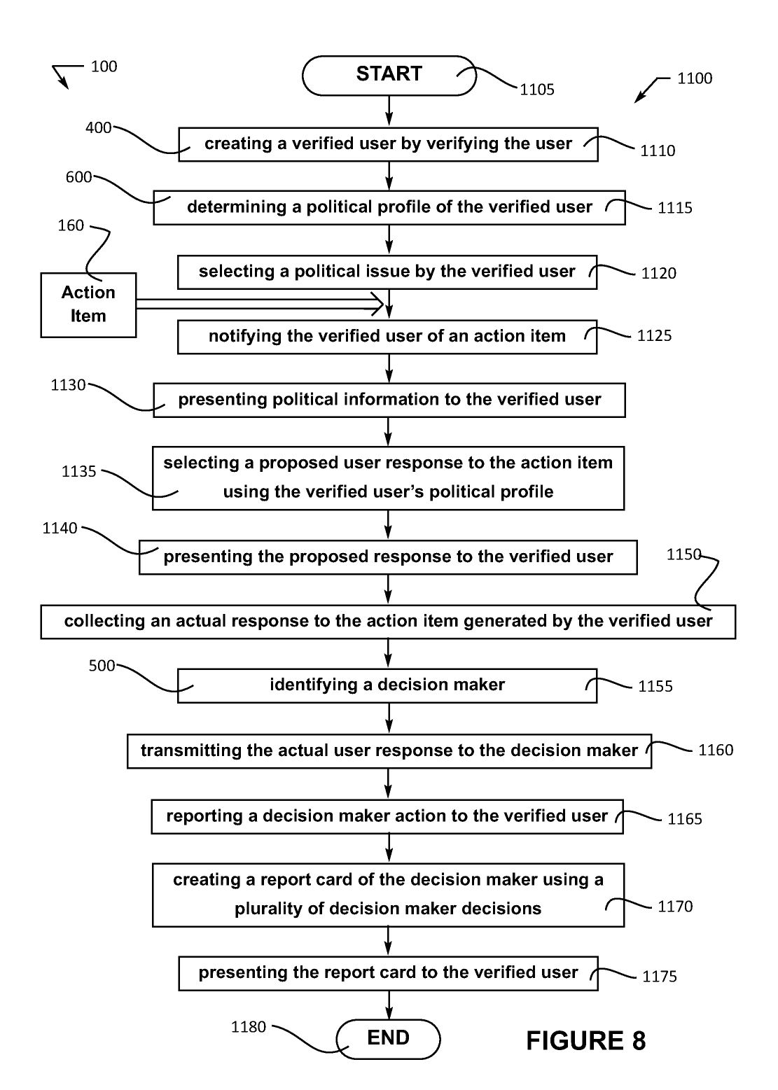

FIG. 8 illustrates portions of system 100 including component 1100, which is a process operable to implement various features of system 100. As illustrated in FIG. 8A, component 1100 is entered at step 1105. At step 1110, in this implementation, component 1100 creates verified user 60 by verifying the identity of user 40. Step 1110 may be implemented, for example, by component 400.

At step 1115, in this implementation, component 1100 determines political profile 180 of verified user 60. Step 1115 may be implemented by component 600, for example.

The verified user 60 selects one or more issues at step 1120 of the implementation of component 1100 that verified user wishes to monitor. Step 1120 may be implemented using user interface 125. The user may select the one or more issues using the select issue interface 210. The select level interface 205, select priority interface 215, and the delivery control interface 220 may implement portions of step 1120, and accordingly, step 1120 may include interactions with the select level interface 205, select priority interface 215, and the delivery control interface 220.

Between steps 1120 and 1120, political process 50 generates action item 160, and action item 160 is transmitted to system 100.

At step 1125, in this implementation, component 1110 of system 100 notifies verified user 60 of action item 160. Step 1125 may be implemented in part by the SAM available notification interface 240 of user interface 125.

At step 1130, in this implementation, component 1100 of system 100 presents political information 134 to verified user 60 related to the issue selected by verified user 60 at step 1120. Political information 134 may include action item description 305 of action item 160, action item summary 310, pro statement 315 favoring action item 160 and con statement 320 opposing action item 160, and component 1100 may use SAM 130 to present political information 134 to verified user 60 at step 1130. For example, upon receipt of the notification per step 1125, verified user 60 may select display SAM interface 245 of user interface 125 to display SAM 130, which then causes component 1100 to present SAM 130 to verified user 60, for example, by display upon computer screen 123.

At step 1135, in this implementation, component 1100 of system 100 selects proposed response 325 to action item 160 based upon the political profile 180 of verified user 60.

At step 1140, in this implementation, component 1100 of system 100 presents the proposed response 325 that was selected at step 1135 to verified user 60. Proposed response 325 may be included in SAM 130, which may be presented to verified user 60 via display on computer screen 123 as controlled by user interface 125. Note that steps 1125, 1130, 1135, 1140 are exemplary, and steps 1125, 1130, 1135, 1140 may be performed in various sequences or simultaneously, in various implementations, which is generally true of the various process flow charts presented herein.

As illustrated in FIG. 8, component 1100 of system 100 proceeds from step 1140 to 1150. At step 1150, in this implementation, component 1100 of system 100 collects actual response 140 to action item 160 from verified user 60. Verified user 60 may enter actual response 140 using response interface 350 of SAM 130, and component 1100 may interact with response interface 350 of SAM 130 at step 1150 to collect actual response 140.

At step 1155, in this implementation, component 1100 identifies decision maker 80. Step 1155 may be implemented, for example, by component 500.

At step 1160, in this implementation, component 1100 of system 100 transmits the actual response 140 to the decision maker 80. Decision maker 80 is now informed of the actual response 140 of verified user 60 with respect to action item 160.

At step 1165, in this implementation, component 1100 of system 100 reports decision maker action 170 of decision maker 80 to verified user 60. Decision maker action 170 may be reported using computer screen 123 of computer 122 and verified user 60 may use user interface 125 to control the reporting of decision maker action 170 at step 1165.

At step 1170, in this implementation, component 1100 of system 100 creates report card 150. Report card 150 may include a number of action item summaries of a number of action items, such as action item summary 305 of action item 160, along with a corresponding number of actual responses and number of decision maker actions, such as actual response 140 and decision maker action 170.

At step 1175, in this implementation, component 1100 of system 100 presents report card 150 to verified user 60. Report card 150 may be presented to verified user 60 using computer screen 123 of computer 122. Verified user 60 may control the presentation of report card 150 as by step 1170 using user interface 125. Component 1100 terminates at step 1180.

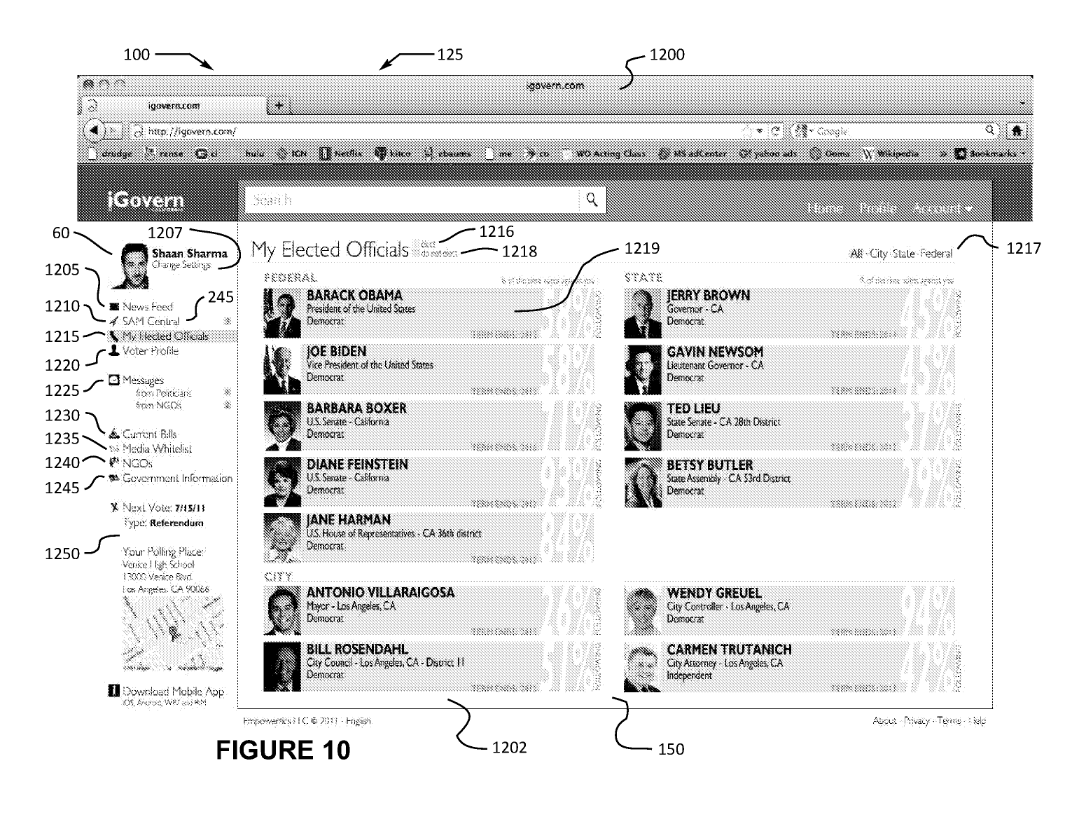

FIG. 10 illustrates an exemplary screen 1200 that includes portions of user interface 125. As illustrated in FIG. 10, screen 1200 identifies the identified user 60. Screen 1200 includes settings selection 1207 that allows verified user 60 to alter the verified user's interactions with system 100, for example, by providing access to performance settings 200 and similar that may alter the functionality of system 100 at least from the point of view of identified user 60.

Selectable interface 1205, 1210, 1215, 1220, 1225, 1230, 1235, 1240, 1245 alters the display in display region 1202, in this implementation, so that selection of one of selectable interface 1205, 1210, 1215, 1220, 1225, 1230, 1235, 1240, 1245 may display corresponding information and additional selectable interfaces in display region 1202.

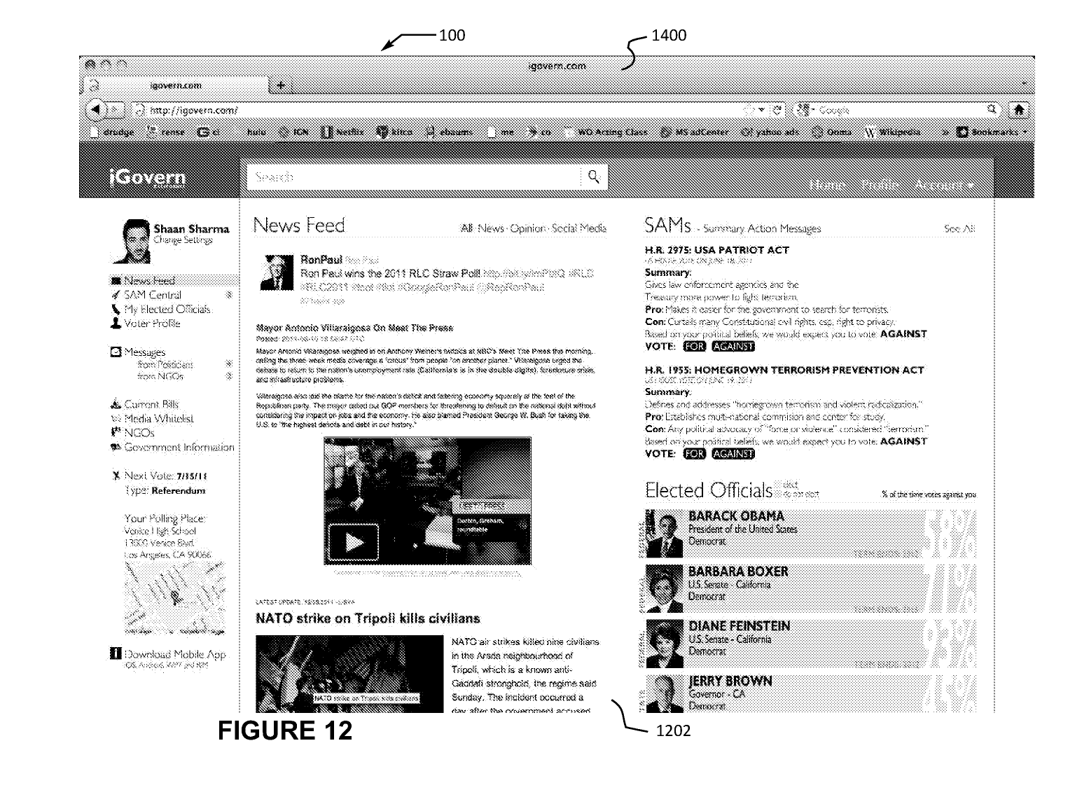

Selectable interface 1205 displays news feeds including written material and video in display region 1202. Audio feeds may be played by computer 122, and the audio feed may be played in conjunction with the news displayed in display region 1202. The news so displayed may be from sources selected by the verified user 60. Selection of selectable interface 1205 may cause the display of various selectable interface in display region 1202 that allow the verified user 60 to select a particular new item for display in display region 1202, select news sources, or otherwise control the display of news in display region 1202. FIG. 12 illustrates exemplary screen 1400 that includes news feeds. Exemplary screen 1400 may be accessed by selection of selectable interface 1205.

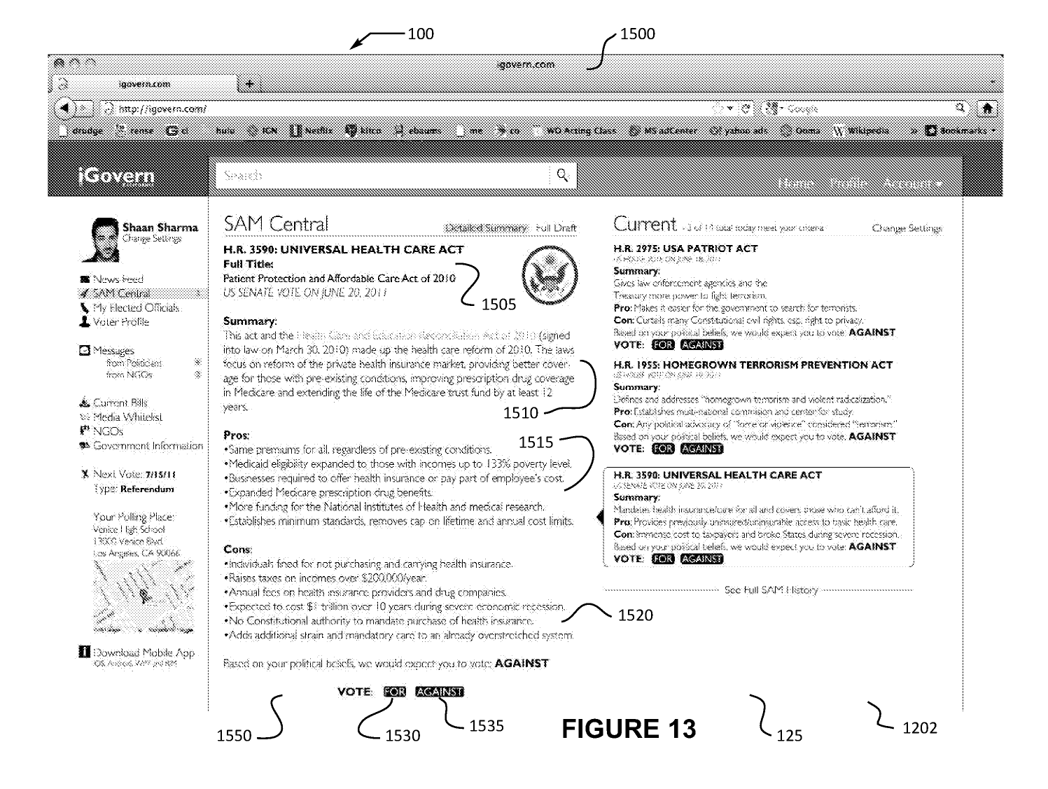

Returning to the discussion of FIG. 10, selectable interface 1210 displays selectable interfaces related to an implementation of SAM 1550. SAM 1550 is displayed in exemplary screen 1500. SAM 1550 in the implementation illustrated in FIG. 13 includes action item summary 1505, pro statement 1515, con statement 1520, and response buttons 1530, 1535 that allow the verified user 60 to enter the verified user's 60 actual response, such as actual response 140. The verified user 60 may enter actual response by selection of either response button 1530 or response button 1535 in this implementation.

Selectable interface 1215 displays information related to decision makers associated with verified user 60 as an implementation of portions of report card 150. For example, as illustrated in FIG. 10, decision makers 80 include decision makers at the local, state, and federal level. Selectable interface 1215, in this implementation, includes selectable interface 1217 that allows verified user 60 to toggle the display between the city, state, or federal level, or the combined city, state, and federal level. As illustrated, the combined city, state and federal level is selected so that decision makers 80 at the city, state and federal level are displayed. By selecting state at selectable interface 1217, the verified user would display only decision makers at the state level (e.g. Brown, Newsom, Lieu, Butler).

Display 1219 displays the identity of the decision maker 80 (e.g. Barack Obama—President of the United States), political affiliation (e.g. Democrat), the date that the decision maker's term ends (e.g. 2012), and the percent of disagreement between the decision maker 80 and the verified user 60 (e.g 58%). Based upon the percent of disagreement between the decision maker 80 and the verified user 60, system 100 may recommend that verified user 60 vote for 1216 or against 1218 the decision maker 80. In the example of FIG. 10, system 100 recommends that verified user 60 vote against President Obama and recommends that verified user vote for California Governor Jerry Brown.

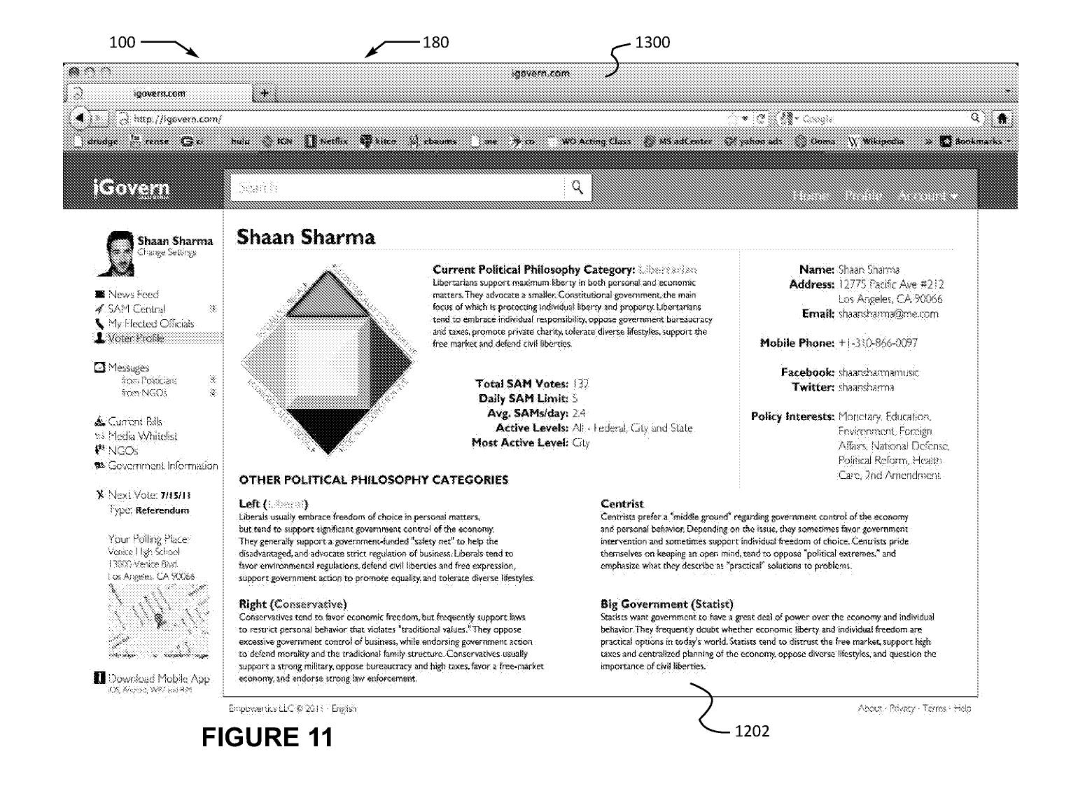

Selectable interface 1220 displays the political profile 180 of verified user 160. An exemplary political profile 180 for verified user 60 is displayed in exemplary screen 1300, as illustrated in FIG. 11.

Selectable interface 1225 of FIG. 10 displays messages in display region 1202. The messages may be from politicians, interest groups, NGO's, etc.

Selectable interface 1230 of FIG. 10 displays current bills (e.g. action items 160) that the verified user 60 is tracking, as illustrated in FIG. 13.

Selectable interface 1235 of FIG. 10 displays news sources that verified user 60 wishes to receive news feeds from, and the new sources may provide the news feeds displayed via selectable interface 1205. Selectable interface 1235 may access additional selectable interfaces that allow verified user 60 to select new sources, de-select news sources, or otherwise manage news sources.

Selectable interface 1240 of FIG. 10 may display links to various NGO's including web sites and may allow the NGO's to communicate with verified user 60 and may allow verified user 60 to communicate with the various NGO's by email and other communication links. Based on issues selected by the verified user 60, system 100 may match the verified user 60 with specific NGOs and give the verified user 60 the option to connect with the specific NGO's or the option to allow the specific NGOs to contact the verified user 60.

Selectable interface 1245 of FIG. 10 may display links to various government web sites and other sources of government information.

Screen 1200 illustrated in FIG. 10 may include electoral information 1250 indicative of the time and place of the next election, and the electoral information 1250 may be derived, at least in part, from the geographic location of verified user 60. As illustrated in FIG. 10, the next election is a referendum on Jul. 15, 2011 with polling place at Venice High School in Los Angeles, Calif. A street map indicative of the location may be included, as illustrated.

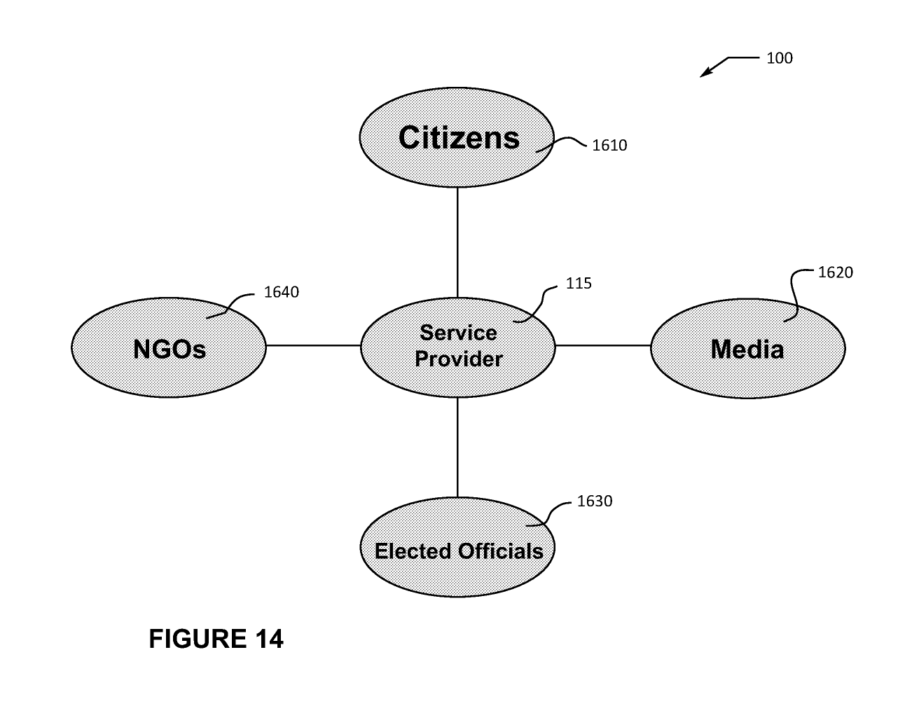

As illustrated in FIG. 14, the methods and systems disclosed herein such as system 100 including service provider 115 may link citizens 1610, media 1620, elected official 1630, and NGO's 1640. System 100 may give verified user 60 an online command center that may enhance verified user's 60 participation in local, state and national politics. System 100 may connect participants in the political system together in one integrated and comprehensive place, providing each with the tools tailored to their unique role in the political process. For example, as illustrated in FIG. 14, methods and systems disclosed herein such as system 100 may link citizens 1610, media 1620, elected officials 1630, and NGO's 1640 to enable:
Citizens 1610 to perform their civic duties and hold their elected officials 1630 accountable.
Elected officials 1630 to stay informed about the wishes of the citizens 1610.
Media 1620 to track issues, bills and government activity web-wide and access real-time polling data.
NGO's 1640 to connect with the citizens 1610 and elected officials 1630 who share the NGO's 1640 political advocacy interests.
Elected official 1630 including other governmental entities to deliver information and services to citizens 1610.

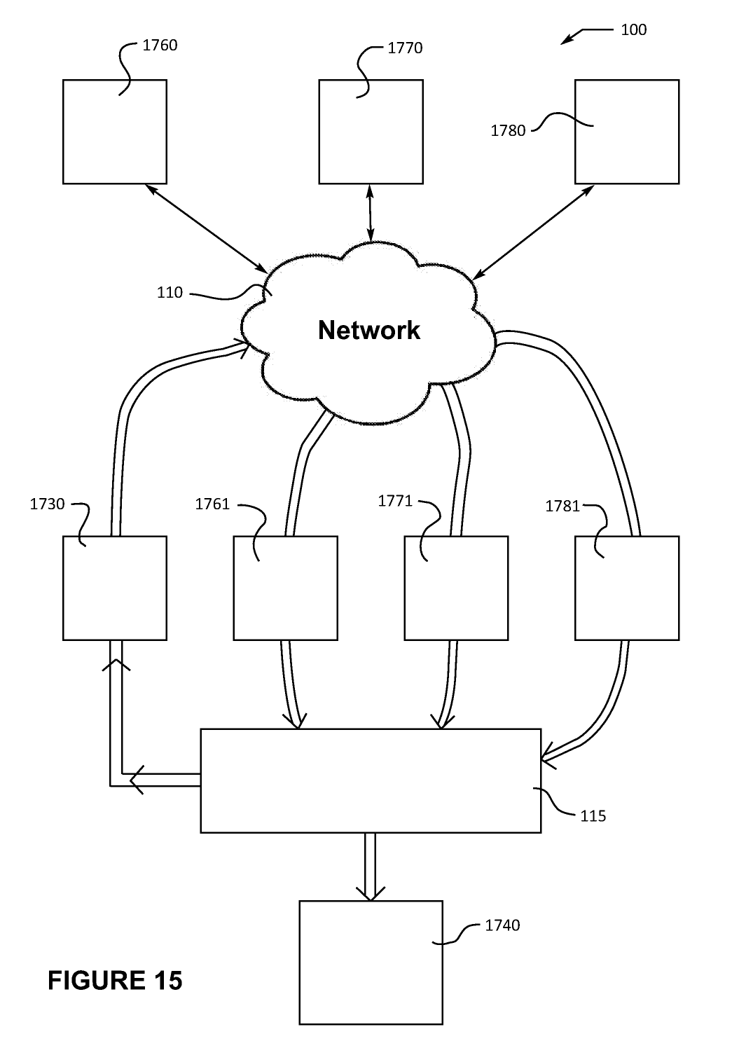

FIG. 15 illustrates the methods and systems disclosed herein such as system 100 including service provider 115 as used in polling to obtain the actual responses 1761, 1771, 1781 of verified users 1760, 1770, 1780, respectively. As illustrated in FIG. 15, action item 1730 is transmitted to verified users 1760, 1770, 1780 by service provider 115. Action item 1730 may be may be any particular matter including various issues within political process 50. Action item 1730 may be communicated to verified users 1760, 1770, 1780 by SAM such as SAM 130, 1550 or otherwise communicated to verified users 1760, 1770, 1780 by user interface 125. Verified users 1760, 1770, 1780 may enter actual responses 1761, 1771, 1781 through user interface 125. Actual responses 1761, 1771, 1781, as illustrated, are transmitted to service provider 115, where actual responses may be collected, aggregated, and analyzed to produce poll result 1740. In other implementations, actual responses 1761, 1771, 1781 may be transmitted by service provider 115 to another entity or entities for analysis.

In various implementations, the verified user 60 may suggest issues to the decision maker 80 that the verified user 60 is concerned about. When other verified users also suggest issues, the issues are ranked and displayed to the decision maker 80. The system, in some implementations, may rank the concern such that more verified users, such as verified user 60, who suggest the same issue, the higher the issue ranks. The issues and the corresponding ranking may be communicated to the decision maker 80. Accordingly, the decision maker 80 can see what issues are important to their constituents.

In various implementations, citizens may use the methods and systems disclosed herein to monitor activities within the political process 50. In various implementations, the methods and systems disclosed herein may be used by news organizations, various media organizations and journalists to monitor activities within political process 50 including, for example, the activities of politicians, elected representatives, elected or appointed officials, NGOs, bills and other matters. In various implementations, the methods and systems disclosed herein may be integrated with government websites to provide information about government activity directly to verified users as well as to manage certain online government services as a private sector contractor. Government services may include renewal of vehicle and other registrations, file taxes, apply for government benefits, and provide feedback to government departments. In various implementations, the methods and systems disclosed herein may be used to provide secure, online voting as an alternative to voting in-person. In various implementations, the methods and systems disclosed herein may be employ biometric identification of the verified user using technologies like facial recognition and fingerprint scanning—which many current computers can implement by using USB peripherals and Web-Cams. In various implementations, the methods and systems disclosed herein may utilize biometric identification to provide secure online voting wherein the biometric identification is used to confirm the identity of the voter voting online.

In various implementations, the methods and systems disclosed herein may be include an aggregated content stream that may include, for example, online news, opinion and social media content pulled from online sources that a verified user has added to the verified user's media whitelist and only the content that the user has indicated they want to receive. The aggregated content stream may be streamed to the user interface, and the user interface may include various controls for the control of the aggregated content stream.

In various implementations, the methods and systems disclosed herein, the user interface may list the date of the verified user's next city, state or federal election or referendum, along with the details of the vote and the user's polling location. Verified users may enable these dates to be added to their personal calendars automatically.

In various implementations, the methods and systems disclosed herein may provide the verified user with a custom reference sheet for each action item of an election that may be accessible via \mobile device or to be printed out and taken to the polls. The custom reference sheet may be based on the vote history of the verified user and political orientation of the verified user so that each ballot item on the reference sheet may list how one with the verified user's political orientation might be expected to vote. Accordingly, even if the verified user does not know how to vote on a particular action item or the verified user fails to remember how to vote on a particular action item, the verified user may be confident that the verified user's vote may be consistent with the verified user political orientation.

In various implementations, the method for engaging a verified user in a political process disclosed herein may include the steps of notifying a verified user of an action item, the action item relating to a political issue preselected by the verified user, and presenting political information to the verified user, the political information relating to the action item. In various implementations, the method for engaging a verified user in a political process disclosed herein may include the steps of selecting a proposed response to the action item using a political profile of the verified user, presenting the proposed response to the verified user, collecting an actual response to the action item generated by the verified user, and transmitting the actual response to a decision maker. In various implementations, the method for engaging a verified user in a political process disclosed herein may include the step of verifying a user thereby creating a verified user.

In various implementations, the method for engaging a verified user in a political process disclosed herein may include the step of verifying a user thereby creating a verified user. In various implementations, the method for engaging a verified user in a political process disclosed herein may include the step of determining a political profile of the verified user. In various implementations, the method for engaging a verified user in a political process disclosed herein may include the step of selecting the political issue by the verified user. In various implementations, the method for engaging a verified user in a political process disclosed herein may include the step of assigning a level of importance to the action item. In various implementations, the method for engaging a verified user in a political process disclosed herein may include the step of notifying a verified user of an action item. In various implementations, the step of notifying a verified user of an action item is performed when the level of importance exceeds a preselected threshold level of importance. In various implementations, the method for engaging a verified user in a political process disclosed herein may include the step of reporting a decision maker action to the verified user, the decision maker action relating to the action item. The political information includes an action item summary, a pro statement favoring the action item, and a con statement opposing the action item, in various implementations. In various implementations, the method for engaging a verified user in a political process disclosed herein may include the step of determining a geographic location of the verified user. In various implementations, the method for engaging a verified user in a political process disclosed herein may include the step of identifying the decision maker using the geographic location. In various implementations, the method for engaging a verified user in a political process disclosed herein may include the steps of using a plurality of decision maker actions of the decision maker to create a report card based upon the verified user's political profile, and presenting the report card to the verified user.

In various implementations, the systems disclosed herein may include a summary action message, with the summary action message including an action item, an action item summary of the action item, a pro statement favoring the action item, a con statement opposing the action item, a proposed response to the action item selected based upon a political profile of a verified user, a response interface allowing the verified user to generate an actual response to the action item, the actual response transmittable to a decision maker, and wherein said summary action message is electronically configured for transmission to the user using networked communication including the Internet.

In various implementations, the apparatus disclosed herein may in include a summary action message operatively received by a networked computer to present to a verified user, an action item generated by a political process, an action item summary of the action item, a pro statement favoring the action item, a con statement opposing the action item, a proposed response to the action item based upon a political profile of the verified user, and a response interface allowing the verified user to input an actual response to the action item for transmission to a decision maker via networked communication.

In various implementations, computer readable media storing a computer program is disclosed herein. The computer program includes instructions that, when executed, cause a computer to perform the steps of notifying a verified user of an action item generated by a political process, the action item relating to a political issue preselected by the verified user, presenting to the verified user a proposed response to the action item, the proposed response being based upon a political profile of the verified user, collecting an actual response to the action item from the verified user, transmitting the actual response to a decision maker, taking a decision maker action by the decision maker, the decision maker action independent of the actual response, and performing the notifying and transmitting steps using a computer in networked communication.

The foregoing discussion along with the Figures discloses and describes various exemplary implementations. These implementations are not meant to limit the scope of coverage, but, instead, to assist in understanding the context of the language used in this specification and in the claims. Upon study of this disclosure and the exemplary implementations herein, one of ordinary skill in the art may readily recognize that various changes, modifications and variations can be made thereto without departing from the spirit and scope of the inventions as defined in the following claims. Furthermore, the Abstract appended hereto is presented to meet requirements of 37 C.F.R. §1.72(b) only. This Abstract is not intended to identify key elements of the apparatus, methods, and compositions of matter disclosed herein or to delineate the scope thereof.

1. A method, comprising the steps of:
notifying a verified user of an action item generated by a political process, the action item relating to a political issue preselected by the verified user;
presenting to the verified user a proposed response to the action item, the proposed response being based upon a political profile of the verified user;
collecting an actual response to the action item from the verified user;
transmitting the actual response to a decision maker;
taking a decision maker action by the decision maker, the decision maker action independent of the actual response; and
performing the notifying and transmitting steps using a computer in networked communication.

2. The method of claim 1, further comprising the step of:
performing the steps of notifying, presenting, and collecting by using a summary action message, the summary action message comprising:
the action item;
an action item summary of the action item;
a pro statement favoring the action item;
a con statement opposing the action item;
the proposed response to the action item; and
a response interface for collecting the actual response.

3. The method of claim 1, further comprising the step of:
receiving the actual response by the decision maker using a networked computer.

4. The method of claim 1, further comprising the step of:
receiving an aggregated response by the decision maker using a networked computer the aggregated response comprising a number of actual responses transmitted by a number of verified users.

5. The method of claim 1, further comprising the step of:
determining a political profile of the verified user.

6. The method of claim 1, further comprising the step of:
preselecting the political issue by the verified user.

7. The method of claim 1, further comprising the step of:
assigning a level of importance to the action item.

8. The method of claim 1, wherein the step of notifying a verified user of an action item is performed when the level of importance exceeds a preselected threshold level of importance.

9. The method of claim 1, further comprising the step of:
reporting a decision maker action to the verified user, the decision maker action related to the action item.

10. The method of claim 1, further comprising the step of:
verifying a user thereby creating a verified user.

11. The method of claim 10, wherein the step of verifying a user is performed using a credit card, passport, birth certificate, or driver's license.

12. The method of claim 1, further comprising the step of:
identifying the decision maker using a geographic location of the verified user.

13. The method of claim 1, further comprising the step of:
using a plurality of decision maker actions of the decision maker to create a report card, the report card indicative of the agreement of the decision maker with the verified user; and
presenting the report card to the verified user.

14. The method of claim 1, wherein the action item is configured as a bill pending before the U.S. House of Representatives, a bill pending before the U.S. Senate, or a bill awaiting signature by the President.

15. The method of claim 14, wherein the decision maker is a member of the United States House of Representatives, a member of the United States Senate, or the President of the United States.

16. (canceled)

17. (canceled)

18. A method, comprising the steps of:
notifying a verified user of an action item generated by a political process, the action item relating to a political issue preselected by the verified user;
presenting to the verified user a proposed response to the action item, the proposed response being based upon a political profile of the verified user;
collecting an actual response to the action item from the verified user;
transmitting the actual response to a decision maker;
taking a decision maker action by the decision maker, the decision maker action independent of the actual response;
creating a report card using a plurality of decision maker actions of the decision maker, the report card indicating agreement between each decision maker action of the plurality of decision maker action with the corresponding actual responses of the verified user;
presenting the report card to the verified user; and
using a computer in networked communication in performing the step of notifying a verified user of an action item generated by a political process, the step of transmitting the actual response to a decision maker, and the step of transmitting the actual response to a decision maker.
